(19) United States
(12) Patent Application Publication
(10) Pub. No.: US 2006/0031300 A1
(43) Pub. Date: Feb. 9, 2006

(54) Method and system for the phased retrieval of data

(76) Inventors: Martijn Willem Maria Kock, Amsterdam (NL); Dirk Groten, Leiden (NL)

Correspondence Address: MICHAELSON AND WALLACE;PARKWAY 109 OFFICE CENTER, 328 NEWMAN SPRINGS RD, P O BOX 8489, RED BANK, NJ, 07701, US

(21) Appl. No.: 10/523,879

(22) PCT Filed: Aug. 29, 2003
(86) PCT No.: PCT/EP03/09734

§ 371 Date: Feb. 7, 2005

Related U.S. Application Data
(60) Provisional application No. 60/407,778, filed on Aug. 30, 2002.

(51) Int. Cl. G06F 15/16

(52) U.S. Cl. 709/206

(57) ABSTRACT

In a method of retrieving electronic messages the server (2) sends the header and the first N text characters of th message body to the terminal device (1), while holding back any remaining text and any attachments. The server also sends a first flag indicative of any remaining text characters and a second flag indicative of any attachments to the terminal device. The user (5) of the terminal device can then decide to retrieve more text characters and/or any attachments. This phased message retrieval avoids downloading oversized messages and thus saves bandwidth. The terminal device (1) may be a handheld device, for example a mobile telephone or a PDA.

The present invention relates to a method and a system for the retrieval of data. More in particular, the present invention relates to a method of retrieving electronic messages, such as e-mail messages, from a server.

Electronic messages intended for a particular recipient are typically stored on a server from where the recipient can retrieve her messages. The stored messages are kept in an electronic mail box which can be remotely accessed. To this end, the recipient's user device or terminal establishes a connection with the server. This connection may involve a telephone dial-in connection, an ADSL connection or a wireless connection. The time required for retrieving the message depends on the bandwidth of the connection and the size (number of bytes) of the message. Messages that only contain plain text usually require relatively little time to retrieve, unless the text is very long and/or the bandwidth is limited, as may be the case when a wireless connection of relatively poor quality is used. Electronic messages are sometimes so large (that is, consist of so many bytes) that their retrieval takes half an hour or more, which obviously is inconvenient. Extremely large messages can sometimes prove impossible to retrieve.

U.S. Pat. No. 6,360,252 discloses a method of presenting e-mail which involves removing the attachments from a message and thus producing a presentation version of the message which contains a descriptor of the removed attachment. Upon request, the server produces an output version of the attachment which is then output to a specific rendering device, such as a fax machine.

This known method has the advantage that the overall size of the message is considerably reduced by the removal of the attachments. In addition, a rendering device can be selected which is suitable for the specific type of attachment. However, this known method has the disadvantage that it leaves the body of the message, that is the text part, unaffected. Particularly long message bodies can still take an undesirably long time to retrieve. In addition, rendering the attachments on a different device from the user device may be impractical as the user may not be in the vicinity of such a device.

It is an object of the present invention to overcome these and other problems of the Prior Art and to provide a method of and a system for retrieving electronic messages which even further reduces the transmission time required.

Accordingly, the present invention provides a method of retrieving an electronic message from a server using a terminal device, the message comprising a header and a body capable of containing characters, the method comprising the steps of:
establishing a communications link between the server and the terminal device,
the server transmitting the header and the first N characters of the body to the terminal device, where N is a predetermined integer, while holding back any remaining characters of the body and any attachments,
the server transmitting a flag indicative of any remaining characters of the body and/or any attachments to the terminal device.
   By not transmitting the attachments with the initial message, an important time and bandwidth saving is achieved. By additionally limiting the body of the initial message to N characters, where N may be any suitable number such as 100 or 1000, a further time and bandwidth reduction is achieved. By additionally transmitting a flag indicative of any remaining parts of the message, the user can selectively retrieve the electronic message in consecutive “phases”.

The phased retrieval according to the present invention is therefore very effective in avoiding the transmission of any unwanted message parts. This reduces the transmission time of the message and accommodates any memory restraints of the terminal device.

The flag may be null if no characters and/or attachments remain on the server, in which case the flag may be omitted. It is preferred, however, that a flag is transmitted even if there are no remaining message parts. In a preferred embodiment, the flag comprises a first flag indicative of any remaining characters and a second flag indicative of any (remaining) attachments. By providing two flag sections, the user is offered a better overview of any remaining message parts, thus allowing a better selection of the message parts.

After the first retrieval phase the terminal device is capable of presenting the first part of the message, the first N characters of the body, to the user. The user can then decide whether she wants to retrieve the remainder of the body, if any, as indicated by the first flag. The terminal device also alerts the user to the presence of any attachments on the basis of the second flag or flags. If there are any remaining parts of the message the user wishes to retrieve, one or more of those remaining parts are retrieved in the second retrieval phase. The user may retrieve further message parts in a third, fourth, or subsequent phase.

It is possible that there are no remaining parts after executing the first phase because there are no attachments and the body of the message has a size of less than N characters. It is also possible that there are remaining message parts but that the user is not interested in retrieving them. Preferably, however, the method of the present invention comprises the further step of the terminal device requesting, in response to the first and/or second flag, the server to send a further P (where P is an integer) characters and/or a selected attachment respectively.

The integer N indicating the number of characters initially retrieved from the server may be a fixed number, set by the hardware manufacturer or by a system maintenance technician. In an advantageous embodiment, the number N is set by the server, possible is response to system and/or terminal device requirements. However, in another advantageous embodiment the number N is determined by a user of the terminal device. That is, the user may be capable of setting and/or adjusting the number of characters retrieved during the first retrieval phase. The number (integer) N may be determined in accordance with user preferences and/or hardware limitations such as a screen size. It is preferred that the number P indicating the number of characters (if any) retrieved during a second or subsequent retrieval phase is also determined by the user. It is noted that the number P may be equal to the number N, but this is not required. Similarly, the number of characters (if any) retrieved during a third or fourth retrieval phase, if applicable, may be equal but does not need to be equal to P and may be different numbers Q and R respectively.

The numbers N, P, Q . . . of characters retrieved per phase is preferably 1000 or 1024, although other numbers may also be used, such as 500 or 512, 100 or 128, 2000 or 2048, or any other suitable number. According to a further aspect of the present invention, N can be set to an “infinite” value (preferably a special, reserved number) indicating that the entire body plus attachments is to be retrieved and that the phased retrieval is effectively switched off. Similarly, another reserved value may be provided which provides the user with the option of retrieving the entire body of the message but not the attachments.

It is noted that instead of, or in addition to, the maximum number of characters retrieved during a retrieval phase a maximum number of lines may be defined. Alternatively, or additionally, a mechanism may be provided which avoids text being cut off in the middle of a word or a sentence. Such a mechanism may shorten or possibly slightly lengthen the message so that any retrieval phase ends, for example, with a space or a period.

When executing the further step of the terminal device requesting, in response to the first and/or second flag, the server to transmit a further P characters and/or at least one selected attachment respectively, these further characters and/or selected attachment(s) are preferably sent to the terminal device. It is, however, also possible for the server to send the message parts of the second or further phase to another device, such as a desktop PC, a fax machine, etc.

The server may carry out automatic mail box management, thus relieving the user of this task. In a preferred embodiment, for example, the server erases the message after transmission if there is no remaining text and no attachments. Conversely, the server preferably retains the message if any remaining characters or any attachments are not yet transmitted. However, this may be made subject to storage capacity. When the server stores messages in a mailbox having a limited capacity, a partially transmitted message may be erased if additional mailbox capacity is required. That is, remaining parts of messages left on the server may for example be deleted if any incoming messages require storage while insufficient storage capacity is left. The deletion of remaining parts of messages may depend on their age, parts of older messages preferably being deleted first.

Although the terminal device may be any device capable of communicating with a server and receiving electronic messages, the terminal device is preferably a mobile handset or a PDA (Personal Digital Assistant).

The present invention further provides a system for retrieving electronic messages, the system comprising a server and a terminal device, wherein the messages comprise a header and a body capable of containing characters, the server and the terminal device being capable of establishing a communications link, wherein
the server is arranged for transmitting the header and the first N characters of the body to the terminal device, where N is a predetermined integer, while holding back any remaining characters and any attachments,
the server is arranged for transmitting a flag indicative of any remaining characters of the body and any attachments to the terminal device.
   Advantageously, the flag may comprise a first flag indicative of any remaining characters and a second flag indicative of any attachments. Alternatively, the flag may be omitted if no further characters and no attachments are available.

In a preferred embodiment, the terminal device is arranged for requesting, in response to the first and/or second flag, the server to send a further P characters and/or a selected attachment respectively.

The present invention additionally provides a terminal device for use in the system defined above, the terminal device being capable of:
establishing a communications link with a server,
receiving the header and the first N characters of the body of a message, and
receiving a flag indicative of any remaining characters and any attachments to the terminal device,
   which terminal device is arranged for requesting, in response to the flag, the server to send a further P characters and/or a selected attachment.

Advantageously, the flag may comprise a first flag indicative of any remaining characters and a second flag indicative of any attachments. Alternatively, the flag may be omitted if no further characters and no attachments are available.

The terminal device is preferably arranged for mobile telephony and may, for example, be a handset for use with GSM, GPRS, UMTS, etc. The terminal device may alternatively be a PDA capable of wireless communication, either by means of cellular (mobile) telephone networks or by means of infra-red communication, using a wireless protocol such as Bluetooth®.

The present invention will further be explained below with reference to exemplary embodiments illustrated in the accompanying drawings, in which:

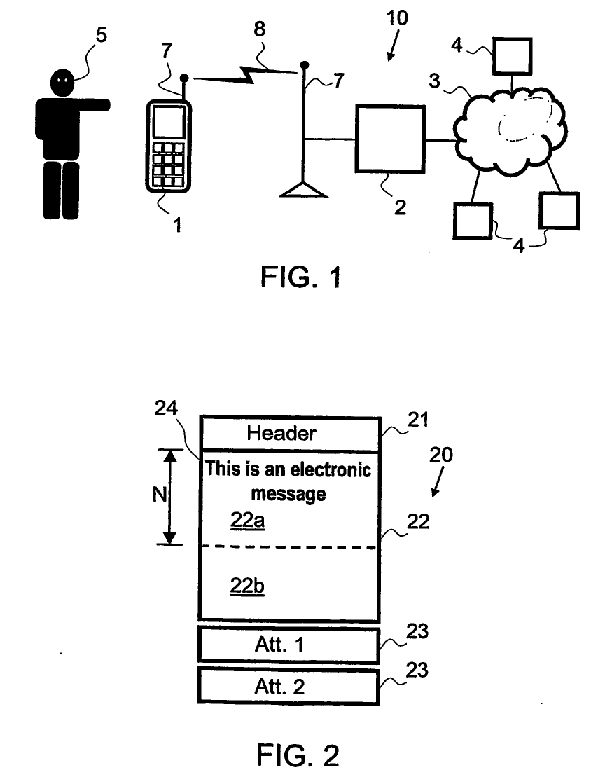

FIG. 1 schematically shows an embodiment of a system according to the present invention.

FIG. 2 schematically shows an electronic message as utilized in the present invention.

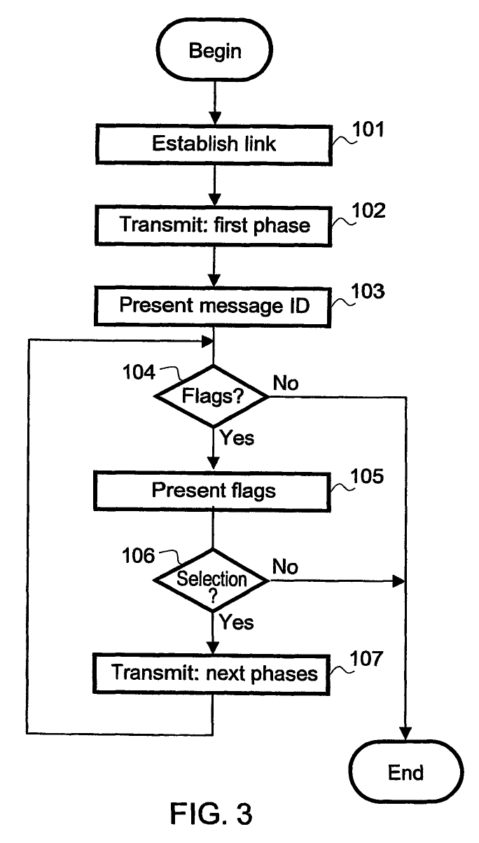

FIG. 3 schematically shows a flow diagram of a method according to the present invention.

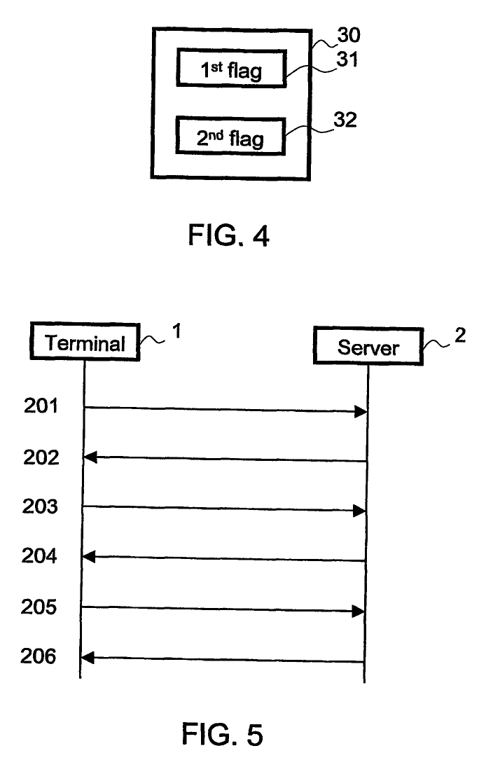

FIG. 4 schematically shows a flag as used in the system and the method of the present invention.

FIG. 5 schematically shows a data exchange as used in the system and the method of the present invention.

The system 10 shown merely by way of non-limiting example in FIG. 1 comprises a user terminal 1, a server 2, a communications network 3, and remote units 4. The terminal 1 is operated by a user 5.

The terminal 1 may be a mobile telephone device, a PDA (Personal Digital Assistant) having communications facilities, a laptop or desktop computer having communications facilities, or any other suitable device. The terminal 1 preferably is a handheld device having a screen and being capable of mobile data communications, for example but not limited to a GSM device having i-mode capabilities.

The server 2 may be any suitable commercially available server capable of handling electronic messages, such as e-mail messages. The server 2 preferably is capable of supporting i-mode data communications. A communications network 3 is coupled to the server 3 and to remote units 4. The network 3 may be any suitable network, such as the Internet, a LAN (Local Area Network) or a WAN (Wide Area Network). The remote units 4 may be further servers which may, for example, produce electronic messages destined for the user 5.

A communications link 6 can be established between the terminal 1 and the server 2 using, for example, antennas 7. The link 6 allows messages to be exchanged between the server 2 and the terminal 3. It will be understood that it is not necessary for the link to be continuous as long as the link 6 allows data to be exchanged between the server 2 and the terminal at certain intervals.

The link 6 is preferably, but not necessarily, at least partially mobile (cellular), that is, wireless. Such communications links typically have a limited bandwidth which may be further reduced by interferences due to bad weather, buildings blocking the transmission path, and other adverse influences. It will be clear that the transmission time required for a message depends on the available bandwidth and the length of the message: when bandwidth is limited, relatively long messages will require a substantial transmission time, which is not always acceptable.

An exemplary e-mail message as may be used in the system 10 is schematically presented in FIG. 2. The message 20 comprises a header 21, a body 22 and attachments 23. The header 21 contains transmission information such as the origin and the destination of the message. The attachments 23 may contain images, sound items, text documents, and other parts of the message which are not part of the body 22. The number of attachments may of course vary and any message may have a single attachment, several attachments or no attachments at all.

The body 22 of the message 20 contains text characters 24. The length of the body 22 may vary as some messages contain no text at all (e.g. only a header and possibly one or more attachments) whereas other message bodies contain thousands of characters.

In accordance with the present invention the transmission time of electronic messages is drastically reduced by substantially reducing the length of the message (it is noted that the length of the message, as this term is used here, may be interpreted as the total number of bytes of the message). This is accomplished by:
removing any attachments,
shortening the body of the message, and
initially sending the message header and the shortened body only, while saving any removed parts of the message for later retrieval, if desired. The transmission of the message is therefore broken down into separate phases: an initial phase in which only the message header and the shortened message body is transmitted, and optional second and subsequent phases in which the remainder of the message body (or part of the remainder) and/or any attachments are retrieved. To facilitate the retrieval in the second (and any subsequent) phase, the server (2 in FIG. 1) may transmit flags to the terminal, a first flag indicating whether any remainder of the message body is available and at least one second flag indicating the availability of any attachments.

As schematically shown in FIG. 2, the message body 22 may be shortened to N characters where N is, for example, equal to 1000. This results in a shortened message body 22a and a remainder 22b. In accordance with the present invention, initially only the shortened body 22a is transmitted, the remainder 22b (as well as any attachments 23) being retained by the server.

It will be understood that the number N may be 20, 100, 500, 512, 1000, 1024, 4096 or any other suitable number. The number N may be determined by the user or by her terminal 1, but in a preferred embodiment the number N is determined by the server 2. Any remainder of the message body may, upon transmission, also be limited to the number N, or be limited to another suitable number. A long message body may be retrieved in more than two phases, the number of characters retrieved in each phase being equal to N, P, Q, etc. respectively, where P and Q are not necessarily equal to N.

Although it is preferred that the shortened message body has a maximum number of N characters, embodiments can be envisaged in which a maximum number of lines, words or sentences is defined.

An embodiment of the method of the present invention is schematically illustrated in the flow diagram of FIG. 3. In step 101 the communications link (6 in FIG. 1) between the server and the terminal is established. In step 102 the server (2 in FIG. 1) transmits the header, the shortened message body and any flags to the terminal (1 in FIG. 1). In step 103, the terminal presents a message identification (ID) to the user. The message identification may, for example, be a subject line and/or the entire shortened message body.

In step 104, it is determined whether any flags are present. If no flags have been received, the message is complete and the transmission is finished. If there is at least one flag, it is presented to the user in step 105. The user may then select a message part identified by a flag in step 106. If a flag was selected, the terminal sends a request to the server for the retrieval of the selected message part(s) and the server responds by transmitting the requested message part in step 107. The corresponding flag(s) is/are deleted and the routine returns to step 104. The routine ends when no more flags are available or when no more flags are selected by the user.

The message identification (ID) mentioned above and which is used to provide a message identification to the user may be used during the method described above to uniquely identify the message and its parts. That is, in any exchange of information between the server and the terminal, the message ID may be used to retrieve further parts of a message, all parts of the same message having the same message ID. When a new message is to be retrieved, either phased or in full, the message ID is typically not available to the terminal prior to the retrieval.

The server may be arranged for deleting a message once it is completely transmitted. The server may also delete a message which is only partially transmitted but for which no further retrieval requests are received within a certain time period.

A flag as used in the present invention is schematically illustrated in FIG. 4. The flag 30 comprises a first section (first flag) 31 and a second section (second flag) 32. The first flag 31 is indicative of any remaining characters, that is, any remaining part of the body (22 in FIG. 2) of the message (20 in FIG. 2). For example, the flag may be “1” if there are remaining characters and “0” if there are no remaining characters.

The second flag 32 is indicative of any (remaining) attachments (23 in FIG. 2). The second flag may contain sub-flags (not shown), each identifying an individual attachment. Embodiments can be envisaged in which the second flag is not sent to the terminal if the message has no attachments, or if all attachment have already been retrieved. Similarly, embodiments can be envisaged in which no flag at all is sent to the terminal. This may be the case when the message contains less than N characters and has no attachments. However, it is preferred to send a flag, if only the first flag, to indicate whether or not any remaining message parts are retrievable.

A preferred embodiment of the present invention is based upon the i-mode mail protocol. In this embodiment, both full retrieval according to the Prior Art and phased retrieval according to the present invention are available. Existing parameters of the i-mode mail protocol are used to convey the additional information required. For example, the ATT parameter in the GET request and the X-EID header are used to distinguish between full retrieval and phased retrieval and to identify messages respectivley. An additional HTTP header, X-MP, is introduced to act as the flags of the present invention, that is, to allow the server to communicate to the client whether there are any remaining message parts. No changes to the syntax of the existing protocol are necessary.

When fall retrieval of all new messages is required, the terminal sends a request in which ATT=ALL while the X-EID value in the GET command is equal to 00000: ALL indicates full retrieval while 00000 indicates all messages. In the response from the server the X-EID value identifies the current message and the next message.

When phased retrieval of all new messages is required, the terminal sends a request in which ATT=PH while the X-EID value in the GET command is again equal to 00000. Again, in the response from the server the X-EID value identifies the current message and the next message. If the current message is not fully retrieved because there are remaining parts on the server, the X-MP flags are set allowing the terminal device to alert the user to the possibility of downloading further parts of the message. When the retrieval of any remaining parts of the message is required, the X-EID value is used to identify the message while the ATT attribute may be used to indicate which part(s) is/are to be retrieved.

The retrieval of messages according to the present embodiment is schematically illustrated in the diagram of FIG. 5, which shows the data exchanged between the terminal 1 and the server 2 during the retrieval of a message xxxxx containing attachments and a message yyyyy which has less than N characters and which has no attachments.

In the non-limiting example of FIG. 5, a first step 201 is carried out upon the receipt of a mail notification or a manual retrieval command. In step 201, the terminal 1 sends the following data to the server:
GET ATT=PH
X-EID: 00000
   indicating that phased retrieval (PH) is to be carried out and that all messages (00000) are to be (partially) retrieved.

In step 202 the server responds by sending the message xxxxx and the following data to the terminal:
HTTP/1.1 200 OK
X-EID: xxxxx/yyyyy
X-MP: True
   where the value of X-EID indicates that the server is sending message xxxxx and has message yyyyy available, while the value of X-MP indicates that there are remaining parts of current message xxxxx (X-MP is True). In step 202, therefore, the server transmits partial message xxxxx to the terminal while storing the remainder of xxxxx. Note that in this embodiment, the server automatically transmits any available shortened message, in the present example xxxxx. Step 202 concludes by the terminal receiving message xxxxx and marking this message as partial in response to the (first) flag X-MP.

In step 203, the terminal issues an automatic request by transmitting the following data to the server:
GET ATT=PH
X-EID: xxxxx/yyyyy
   where the value of X-EID confirms the receipt of the data sent by the server. In response, the server marks message xxxxx as partially read and sends message yyyyy in step 204, also transmitting the following data:
HTTP/1.1 200 OK
X-EID: yyyyy/EIEOF
X-MP: False
   where EIEOF indicates that there are no further messages and where X-MP: False indicates that there are no remaining parts. The terminal receives message yyyyy.

In step 205, the terminal issues an automatic request:
GET ATT=PH
X-EID: yyyyy/EIEOF
   which causes the server to delete message yyyyy, thus freeing storage space. Finally, the server sends in step 206 the following data to the terminal:
HTTP/1.1 251 FIN
X-EID: 00000/00000
   which concludes the procedure.

It is noted that in step 206 no flag (X-MP) is transmitted as there are no remaining message parts.

Although the invention has been explained with specific reference to e-mail messages, it is noted that the invention is not so limited and that other messages, such as data messages, can be retrieved in the manner described above.

The present invention is based upon the insight that transmitting entire electronic messages may require too much time and/or bandwidth and that more effective use can be made of available resources by dividing messages, including message bodies, into parts which may be retrieved separately. The present invention benefits from the further insight that a user may not wish to retrieve all parts of a message, thus further reducing the time and bandwidth required.

It is noted that any terms used in this document should not be construed so as to limit the scope of the present invention. In particular, the words “comprise(s)” and “comprising” are not meant to exclude any elements not specifically stated. Single elements may be substituted with multiple elements or with their equivalents.

It will therefore be understood by those skilled in the art that the present invention is not limited to the embodiments illustrated above and that many modifications and additions may be made without departing from the scope of the invention as defined in the appending claims.

1. A method of retrieving an electronic message from a server (2) using a terminal device (1), the message (20) comprising a header (21) and a body (22) capable of containing characters, the method comprising the steps of:
establishing a communications link (6) between the server and the terminal device,
the server transmitting the header (21) and the first N characters (24) of the body to the terminal device, where N is a predetermined integer, while holding back any attachments (23),
the server transmitting a flag (30) indicative of any remaining characters (24) of the body and/or any attachments (23) to the terminal device.

2. The method according to claim 1, wherein the flag (30) comprises a first flag (31) indicative of any remaining characters and a second flag (32) indicative of any attachments (23).

3. The method according to claim 1, comprising the further step of:
the terminal device (1) requesting, in response to the flag (30), the server (2) to transmit a further P characters (24) and/or a selected attachment (23).

4. The method according to claim 1, wherein the integer N is determined by the server.

5. The method according to claim 4, wherein the server (2) erases the message after transmitting if there is no remaining text and no attachments.

6. The method according to claim 5, wherein the server (2) retains the message if any remaining text or any attachments are not yet transmitted.

7. The method according to claim 6, wherein the server (2) stores messages in a mailbox having a limited capacity, and wherein a partially transmitted messages is erased if additional mailbox capacity is required.

8. The method according to claim 7, wherein the terminal device (1) is a mobile handset or a PDA.

9. A system (10) for retrieving electronic messages, the system comprising a server (2) and a terminal device (1), wherein the messages (20) comprise a header (21) and a body (22) capable of containing characters, the server and the terminal device being capable of establishing a communications link (6), wherein
the server is arranged for transmitting the header (21) and the first N characters (24) of the body to the terminal device, where N is a predetermined integer, while holding back any remaining characters and any attachments,
the server is arranged for transmitting a flag indicative of any remaining characters (24) of the body and any attachments (23) to the terminal device.

10. The system according to claim 9, wherein the flag (30) comprises a first flag (31) indicative of any remaining characters (24) and a second flag (32) indicative of any attachments (23).

11. The system according to claim 9, wherein the terminal device (1) is arranged for requesting, in response to the flag (30), the server (2) to send a further P characters (24) and/or a selected attachment (23).

12. A terminal device (1) for use in the system (10) of claim 9, the terminal device being capable of:
establishing a communications link (6) with a server (2),
receiving the header (21) and the first N characters of the body (22) of a message (20), and
receiving a flag (30) indicative of any remaining characters of the body (22) and any attachments (23) to the terminal device,
which terminal device (1) is arranged for requesting, in response to the flag, the server to send a further P characters and/or a selected attachment.

13. The terminal device according to claim 12, arranged for mobile telephony.
